(19) United States
(12) Patent Application Publication
(10) Pub. No.: US 2025/0219306 A1
(43) Pub. Date: Jul. 3, 2025

(54) HARDLINE CONNECTOR HAVING A SEIZING MANDREL PORTION STRUCTURALLY CONFIGURED TO PROVIDE ENHANCED ELECTRICAL AND MECHANICAL CONNECTIVITY

(71) Applicant: PPC BROADBAND, INC., East Syracuse, NY (US)

(72) Inventor: Henry SAUVAIN, Syracuse, NY (US)

(73) Assignee: PPC BROADBAND, INC., East Syracuse, NY (US)

(21) Appl. No.: 19/006,174

(22) Filed: Dec. 30, 2024

Related U.S. Application Data
(60) Provisional application No. 63/616,340, filed on Dec. 29, 2023.

(51) Int. Cl. H01R 9/05; H01R 13/502; H01R 13/622; H01R 24/40; H01R 101/00

(52) U.S. Cl. CPC H01R 9/0524; H01R 13/502; H01R 13/622; H01R 24/40; H01R 9/0521; H01R 2101/00

(57) ABSTRACT

A connector includes: a first body portion; a second body portion configured to be connected to the first body portion; and a mandrel. The mandrel may comprise a seizure portion and a tubular portion; the seizure portion may have a cantilevered engagement portion structurally configured to physically engage a retention portion of the second body portion; the tubular portion may be structurally configured to position a center conductor portion of a cable in electrical contact with a conductive pin portion; and the conductive pin portion may be structurally configured to engage a female port while the cantilevered engagement portion and retention portion collectively resist rotation of the mandrel and center conductor portion relative to the second body portion to enhance longevity of an electrical connection.

### CROSS-REFERENCE TO RELATED APPLICATION

This application claims the benefit of U.S. Provisional Patent Application No. 63/616,340, filed on Dec. 29, 2023, the disclosure of which is hereby incorporated by reference herein in its entirety.

### TECHNICAL FIELD

The present disclosure is directed to a cable connector and, more particularly, to a hardline coaxial cable connector.

### BACKGROUND

Despite advancements and proliferation of wireless signal transmission, wired connections remain foundational aspects of data, and signal, distribution. Hence, new installations for users of data and other transmitted signals often involve handling, manipulating, and connecting wires and cables. As technological achievements become available, existing wired connections can require reworking, replacement, and/or installation of supplemental components.

The handling of wired connections can place physical stress on various aspects of the structure of the connection, such as the connector, adapter, interface, and port. With some connectors that facilitate a wired connection having threaded aspects that require rotation for installation, rotational forces can pose risks for the integrity and reliability of signal/data transmission.

For these reasons, it is a continued goal for wired connections is to increase a connector's resilience to rotational forces encountered during handling and installation.

Traditionally, a “seizure bushing” and mandrel are separate parts of a connector, with the seizure bushing being a plastic insulator component that prevents the connector's pin from moving freely, and the mandrel being a metal component that the cable is slid on top of and clamped down to. Some designs incorporate a plastic portion of the mandrel on the trailing end (the seizure bushing rests on the other-metal-end of the mandrel in these designs) to improve electrical performance.

### SUMMARY

Embodiments provide a connector having a conductive pin portion that is structurally configured to engage a female port while a engagement portion and a retention portion collectively resist rotation of a mandrel and a center conductor portion relative to a second body portion during rotation of the second body portion relative to a first body portion to enhance longevity of the connection.

Embodiments include unique components that differ from current connector designs, one being the plastic mandrel (possibly injection molded) with a seizure mechanism, and the other being a simple metal portion for support. Since the mandrel is often clamped down on by indefinite force, embodiments include two concepts including a metal part that takes stress off the plastic to prevent creep. One of these has a simple slotted ring that snaps around the plastic and helps take radial stresses, while the other is a metal portion of the mandrel itself, allowing the seizure bushing to be a part of the plastic mandrel. Embodiments include a third design that does not use a metal portion at all. With this design, the geometry of the plastic as well as material choice (for example, high performance plastic such as PAI or PBI) allows the plastic alone to take the stresses of the cable, thus essentially combining three components into one.

Particular embodiments provide a hardline connector to interface between a cable and a terminal port, including: a first body portion; a second body portion; a third body portion; and a mandrel. The second body portion may be configured to rotate to secure to the first body portion; the third body portion may be configured to rotate to secure to the first body portion; the second body portion may comprise a conductive pin portion; the mandrel may comprise a seizure portion and a tubular portion; the third body portion may be structurally configured to engage a clamping portion of the first body portion to secure the tubular portion in place within the first body portion; the seizure portion may comprise a collar portion structurally configured to position a centering portion in contact with a collet portion of a pin conductor portion of the second body portion; the seizure portion may be structurally configured to physically attach to the conductive pin portion to pass electrical signals from a center conductor portion of a cable to the conductive pin portion; the seizure portion may be structurally configured with a engagement portion structurally configured to physically engage a retention portion of the first body portion; the engagement portion may comprise a plurality of separated cantilevered tabs collectively configured to engage the retention portion of the second body portion; and the conductive pin portion may be structurally configured to engage a female port while the engagement portion and retention portion collectively resist rotation of the mandrel and center conductor portion relative to the second body portion during rotation of the second body portion relative to the first body portion to enhance longevity of the connection.

According to various embodiments, the seizure portion and at least a portion of the tubular portion may be one monolithic structure.

According to various embodiments, the monolithic structure may be non-conductive.

According to various embodiments, the monolithic structure may result in improved connector performance, decreased weight, and reduced cost.

According to various embodiments, at least a portion of the mandrel may be configured to be positioned between an outer conductor of the cable and an insulator portion of the cable.

According to various embodiments, the engagement portion may extend from the mandrel to contact a retention sidewall of the first body portion.

According to various embodiments, the retention sidewall may be structurally configured to position the mandrel for physical engagement with the conductive pin portion in response to rotation of the second body portion relative to the first body portion.

According to various embodiments, the second body portion may comprise a centering member portion structurally configured to secure the pin conductor portion in place relative to the mandrel.

According to various embodiments, the tubular portion may have a plurality of longitudinal grooves positioned around a periphery of an internal cavity of the mandrel.

Particular embodiments provide a cable connector including: a first body portion; a second body portion; and a mandrel. The second body portion may be structurally configured to rotate to engage the first body portion; the second body portion may comprise a conductive pin portion; the mandrel may comprise a seizure portion and a tubular portion; the seizure portion may be structurally configured to physically attach to the conductive pin portion to pass electrical signals from a center conductor portion of a cable to the conductive pin portion; the tubular portion may be structurally configured to position the center conductor portion in electrical contact with the conductive pin portion of the second body portion; the seizure portion may have a engagement portion structurally configured to physically engage a retention portion of the second body portion; and the conductive pin portion may be structurally configured to engage a female port while the engagement portion and retention portion collectively resist rotation of the mandrel and center conductor portion relative to the second body portion during rotation of the second body portion relative to the first body portion to enhance longevity of an electrical connection.

According to various embodiments, the engagement portion may comprise a plurality of separated cantilevered tabs collectively configured to engage the retention portion concurrently.

According to various embodiments, each tab of the plurality of cantilevered tabs may engage a separate recess of the retention portion in the second body portion.

According to various embodiments, each recess of the retention portion may be structurally configured as a rectangular notch orientated parallel to a longitudinal axis of the first body portion.

According to various embodiments, the plurality of separated cantilevered tabs may be structurally configured to contact a retention surface of the first body portion to prevent mandrel movement along a longitudinal axis of the first body portion.

According to various embodiments, the retention portion may be structurally configured with a plurality of grooves that collectively surround a periphery of a retention region of the second body portion.

According to various embodiments, the plurality of grooves may be structurally configured as a knurling that provides increased friction to the plurality of separated cantilevered tabs.

According to various embodiments, each tab of the plurality of separated cantilevered tabs may concurrently physically contact separate grooves of the plurality of grooves to restrict rotation of the mandrel relative to the second body portion.

According to various embodiments, the tubular portion may comprise a polymer section attached to a metal section via an attachment ring portion.

Particular embodiments provide a connector including: a first body portion; a second body portion configured to be connected to the first body portion; and a mandrel. The mandrel may comprise a seizure portion and a tubular portion; the seizure portion may have a cantilevered engagement portion structurally configured to physically engage a retention portion of the second body portion; the tubular portion may be structurally configured to position a center conductor portion of a cable in electrical contact with a conductive pin portion; and the conductive pin portion may be structurally configured to engage a female port while the cantilevered engagement portion and retention portion collectively resist rotation of the mandrel and center conductor portion relative to the second body portion to enhance longevity of an electrical connection.

According to various embodiments, wherein the retention portion may comprise a plurality of radially separated recesses in the second body portion.

According to various embodiments, the retention portion may comprise a knurled surface of the second body portion.

### BRIEF DESCRIPTION OF THE DRAWINGS

Further advantages and features of the present disclosure will become apparent from the following description and the accompanying drawings, to which reference is made.

FIG. 1 is a line representation of portions of a wired connection in which assorted embodiments can be practiced.

FIG. 2 is a line representation of portions of an exemplary cable connection assembly that may be employed in the connection of FIG. 1 in various embodiments.

FIG. 3 convey portions of an exemplary hardline connector that can be employed in the wired connection of FIG. 1 in various embodiments of this disclosure.

FIG. 4 convey portions of an exemplary hardline connector that may be utilized in the wired connection of FIG. 1 in various embodiments of this disclosure.

FIG. 5 display portions of an exemplary hardline connector arranged in accordance with various embodiments of this disclosure.

FIG. 6 displays an exploded view of portions of an exemplary hardline connector arranged in accordance with various embodiments of this disclosure.

FIG. 7 is a perspective cross-sectional view of portions of a hardline connector configured with a rotationally stable mandrel in accordance with various embodiments.

FIG. 8 displays a perspective cross-sectional view of portions of a hardline connector arranged with a rotationally stable mandrel configured in accordance with various embodiments.

### DETAILED DESCRIPTION

Embodiments of the disclosure include a connector having a mandrel that comprise a seizure portion and a tube portion, where the seizure portion and at least a portion of the tube portion are one monolithic structure. The monolithic structure results in improved connector performance, decreased weight, and reduced cost.

Reference will now be made in detail to embodiments and methods of the present disclosure, which constitute modes of practicing the present disclosure. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may vary. Furthermore, the terminology used herein is used only for the purpose of describing particular embodiments of the present disclosure and is not intended to be limiting in any way.

During installation and subsequent handling of wired connections, rotational forces can be encountered. Some connectors, such as hardline coaxial cable connectors, position components to provide an electrically stable conductor, which can be jeopardized by encountered rotational forces. Thus, various embodiments are directed to a hardline coaxial cable connector that mitigates the risk of rotational forces degrading or eliminating the electrical integrity of the connector and any associated electrical connection.

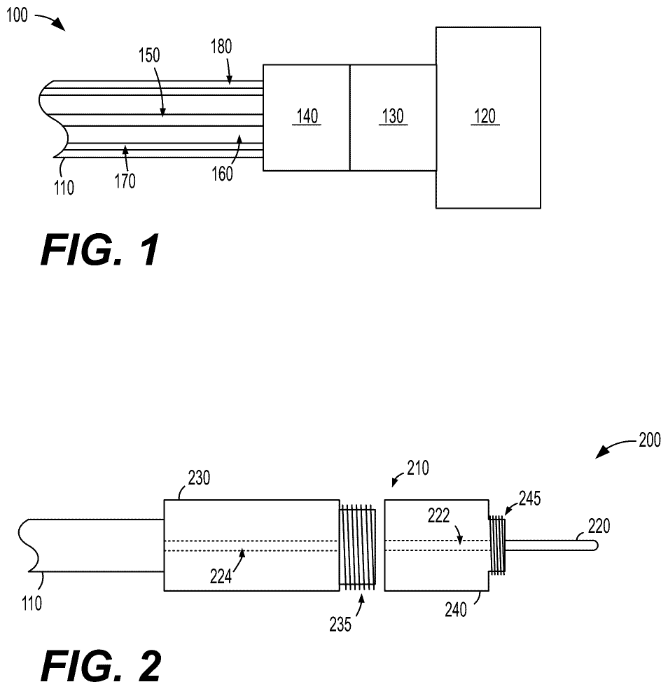

Turning to the drawings, FIG. 1 illustrates a line representation of an exemplary wired connection 100 in which embodiments of a hardline connector can be employed. A cable 110 can form an electrical connection with a terminal 120. The cable 110 can be any length, type, and location to connect to any type of terminal 120 via any type of interconnect. For instance, a coaxial cable 110 can form a stable signal/data pathway with a port 130 of a terminal 120, such as a device, switch, or interface, via a cable connector 140.

It is noted that the cable 110 can originate at a source, such as a transmission hub, amplifier, switch, or computing device. The cable 110 can comprise any number of signal conductors, such as fiber optic or coaxial hardline conductors 150. It is contemplated, but not required, that the cable 110 has multiple integrated signal conductors 150. In the embodiment shown in FIG. 1, the cable 110 has a single signal conductor 150 that is surrounded by a continuous insulating layer 160. A shielding layer 170 is integrated into the cable 110 and can provide electric, magnetic, or other interference protection. An outer cable jacket 180 further provides environmental protection for the cable 110.

FIG. 2 illustrates a line representation of portions of a cable connection arrangement, for example, assembly, 200 which can be employed in the wired connection environment of FIG. 1 in accordance with various embodiments. The connection assembly has an input cable 110 that is physically attached to a connector body 210 that presents a conductive pin portion 220 for engagement with a terminal port 130. The connector body 210 is shown in a disassembled state with a first portion 230 separated from a second portion 240. Although not required or limiting, the body portions 230/240 can physically attach via a male threaded portion 235 of the first portion 230 while a connection portion 245 extends from the second portion 240 to engage and secure to the terminal port 130.

The separate body portions 230/240 allow the first body portion 230, or mid body portion, to be physically secured to the cable 110 while the second body portion 240, or front body portion, remains detached. The subsequent secure physical attachment of the second body portion 240 to the first body portion 230 can provide an electrical/signal connection from at least the signal pathway conductor of the cable 110, such as conductor 150, to the conductive pin 220, as illustrated by the segmented regions 222/224 that, when combined, continuously extend from the cable 110 to the pin 220. This allows for efficient and reliable connection of assembly 200 to connect to a terminal, such as terminal 120.

However, the physical attachment of the respective body portions 230/240 can pose operational difficulties. For instance, rotation of one, or both, of the body portions 230/240 can inadvertently rotate, or spin, internal components of either body portion 230/240. Such rotation of components positioned internal to either body portion 230/240 can jeopardize the quality and/or integrity over time as aspects that support the signal pathway and conductor connection weaken, move, or become unstable. Hence, various embodiments of a connector assembly 200 employ internal body components that resist rotation during installation and use to provide a reliable signal pathway after fabrication and installation.

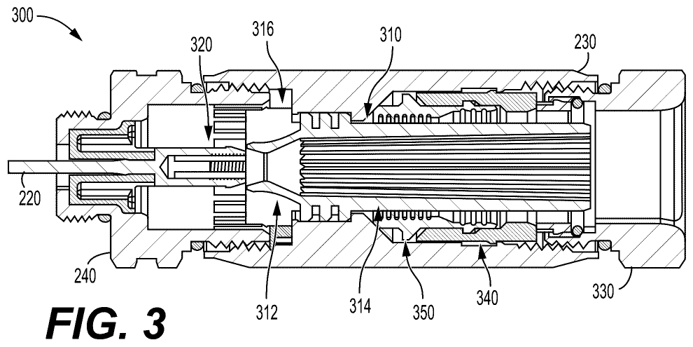

FIGS. 3-6 respectively illustrate portions of a hardline connector 300 arranged in accordance with various embodiments. FIG. 3 is a cross-sectional view of an assembled connector 300 that employs a mandrel 310 configured with a seizure portion 312 integrated with a tube portion 314. By incorporating cantilevered tabs 316 into the seizure portion 312 of the mandrel 310, rotation of the mandrel 310 can be mitigated or eliminated altogether as a result of rotating the second body portion 240 during installation and/or handling. It is noted that rotation is not, necessarily, eliminated by the cantilevered tabs 316 and the mandrel 310 may rotate, but not independently of the first body portion 230 and/or second body portion 240. That is, the cantilevered tabs 316 can ensure the mandrel 310 rotates with the second body portion 240 while the second body portion 240 rotates to engage the first body portion 230, and subsequently the tabs 316 prevent all rotation of the mandrel 310 once the second body portion 240 is fully seated in contact with the first body portion 230.

While not required or limiting, the first body portion 230 of the connector 300 can be installed on a cable, such as cable 110, so that the tube portion 314 of the mandrel 310 supports and positions the signal pathway conductor to securely engage a collet 320 that supports the conductive pin 220. A third body portion 330, or end cap, and clamping member 340 further secure the cable in place relative to the first body portion 230 once the first body portion 230 is fully installed on the cable. As such, the first body portion 230 can be characterized as a compression-type hardline connector 300. Yet, other types of cable arresting configurations can be utilized, such as crimp-type or solder-type connectors.

Embodiments of the mandrel 310 include one or more shielding portions 350 that can completely, or partially, surround the tube portion 314 to provide protection from interference, such as radio frequencies or magnetic fields. The combination of the collet 320 and one or more centering members positioned in the second body portion 240 can physically support the conductive pin 220 without adding undue weight or complexity that can jeopardize the signal strength or quality of the assembled connector 300.

It is noted that the assembled connector 300 is configured to apply consistent force onto the collet 320 to engage and secure the conductive pin 220 via contact with the seizure portion 312 of the mandrel 310, as shown. That is, the collet 320 and seizure portion 312 are respectively arranged to nest and contact one another, once the connector 300 is fully assembled, to consistently apply force that physically secures the conductive pin 220 without degrading the signal quality and reliability from the cable to a connected terminal port, such as port 130.

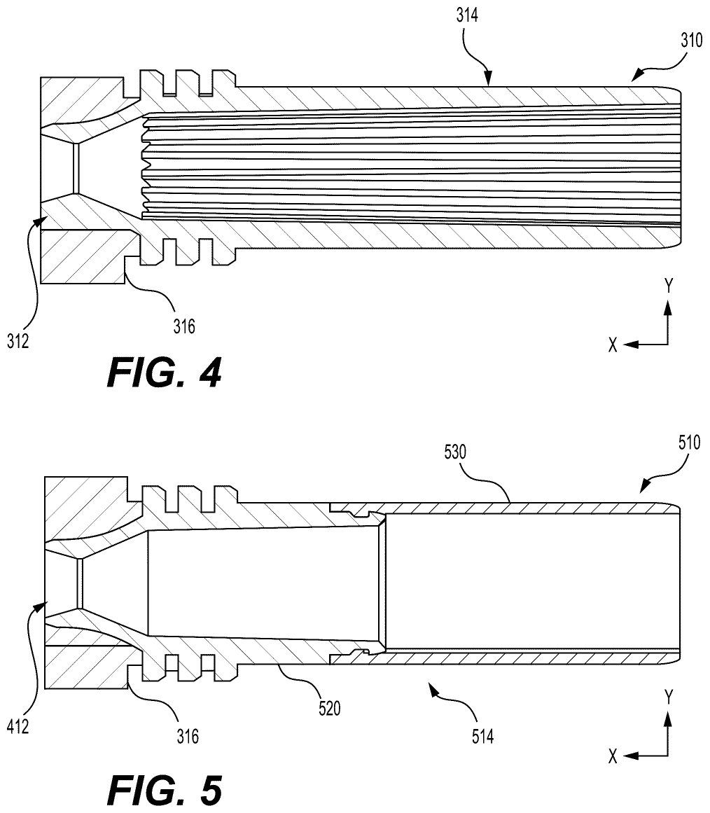

FIG. 4 is a perspective view of the mandrel 310 and conveys how the tube portion 314 transitions into the seizure portion 312 to present the rotation preventing tab(s) 316. The respective cantilevered tabs 316 extending from the mandrel 310 can be any shape, size, material, and position relative to the seizure portion 312 to engage internal structure of the first body portion 230 to prevent rotation or movement of the mandrel 310, which corresponds with a reliable establishment of a secure signal pathway through the connector 300 despite rotation of the first body portion 230 during installation.

FIG. 5 illustrates a cross-sectional view of an integrated mandrel 510 that can be incorporated into the hardline connector 300 of FIG. 3 in accordance with various embodiments. The mandrel 510 can be characterized as integrated by being a single, unitary piece that provides a seizure portion 412 to engage a collet 320, a tube portion 514 to engage a cable, and at least one rotational stop tab 316. The integrated mandrel 510 can be constructed of one or more materials that provide sufficient rigidity, flexibility, conductivity, and lifespan to securely engage the cable and collet while preventing mandrel 510 rotation with the respective tab(s) 316.

In some embodiments, the mandrel 510 is constructed of a single material, such as polymer, elastomer, or a plastic, that provides sufficient strength and operational characteristics to maintain a reliable signal pathway from the cable to the conductive pin portion 220 after rotational assembly of the connector 400 body portions 230/240. It is noted that an integrated mandrel 510 can be constructed with injection molding techniques, although such fabrication is not required. For instance, a single material mandrel 510 can be cast, forged, or otherwise formed to ensure durability and desired operational performance in a connector 400.

Other embodiments of an integrated mandrel 510 utilize multiple materials, such as polymer, metal, ceramic, in the form of components that fit together to operate as a single, unitary part. As a non-limiting embodiment, a solely polymer mandrel body 520 can be connected to a metal portion 530 that operates to provide shielding, such as blocking of radio frequencies or magnetic interference, as well as physical support, such as mitigating radial stresses on the cable that can contribute to unwanted component movement within the connector 400. Comparison of the mandrel 310 in FIG. 4 compared to the mandrel 510 in FIG. 5 conveys how mandrel 310/510 configuration can be tuned and customized without departing from the embodiments of the present disclosure.

It is contemplated that a solely metal mandrel body 520 can be partially, or wholly, surrounded by a solely polymer ring. The ability to tune the material construction of portions of the integrated mandrel 510 allows for a balance of strength and stress damping that can be catered to particular connector applications and/or environments. For instance, a connector designated for hot, cold, humid, wet, or windy environments can have an integrated mandrel 510 customized for material construction to provide a reliable signal pathway from cable to conductive pin portion 220 by exhibiting rigidity and strength characteristics along with flexibility and damping characteristics that combine to establish and maintain a secure electrical connection proximal the seizure portion 412.

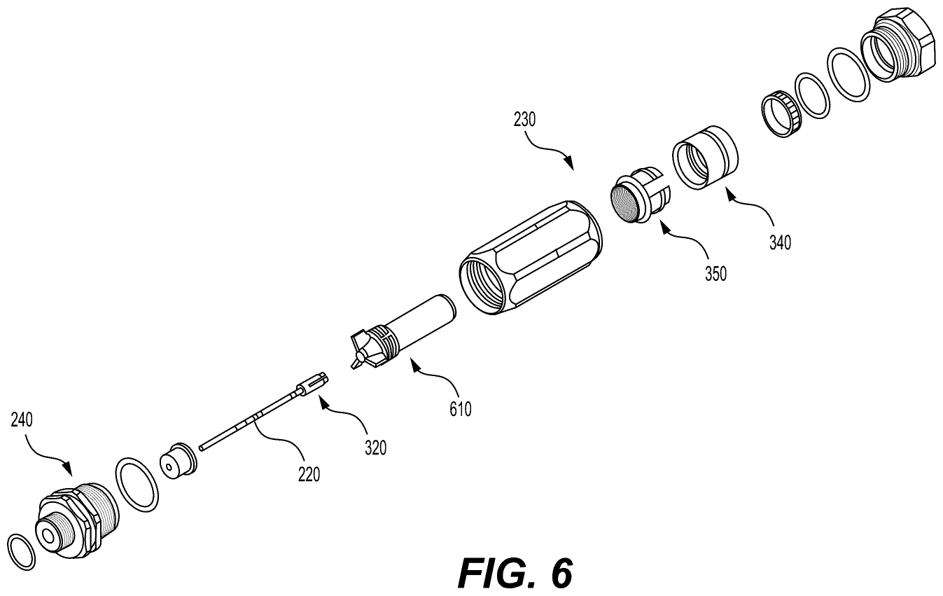

FIG. 6 illustrates an exploded view of a hardline connector 600 that may employ a mandrel 310/510 from FIGS. 3-5 in accordance with various embodiments. The separated arrangement of the various components of the connector 600 convey how the first body portion 230 can physically engage and secure to a cable 110 via the third body portion 350 and clamping member 340 operating in conjunction with the tube portion 314/514 of the mandrel 610.

In practice, installation of the first body portion 230 can involve stripping portions of the cable to all the proper positioning of the respective mandrel 610, clamping member 340, and third body portion 330. Once positioned about the cable 110, the second body portion 240 can be attached to the, now combined, first body portion 230 and cable 110 via one or more attachment mechanisms. The non-limiting embodiments of the connectors 300/600 shown in the assorted drawings illustrate how a threaded attachment mechanism, which includes male portion 235, can rotate relative to the second body portion 240 to provide a secure physical engagement.

The movement of the second body portion 240 toward the first body portion 230 during use of the body attachment mechanism further brings the conductive pin portion 220 into electrical and physical contact with the mandrel 610. More specifically, the collet 320 that surrounds the conductive pin portion 220 contacts the seizure portion 312/412 of the mandrel 610 to establish and maintain a secure connection from the conductive pin portion 220 to the mandrel 610, which corresponds with a continuous signal pathway from the cable 110 to a terminal port, such as port 130 of FIG. 1.

It is contemplated that the hardline connector 600 has a single piece configuration that eliminates the use of a body attachment mechanism. However, the multi-piece configuration shown in FIGS. 3-5 illustrate how a connector 300/600 can allow for mandrel 310/510/610 modularity. That is, a connector body 210 can house differently configured mandrels 310/510/610, which provides interchangeability over time. As a result of such mandrel interchangeability, a connector 300/600 can be effectively deployed in a wide range of operational and environmental conditions as well as efficiently reworked in the field to accommodate changing cables 110, terminals, or operating conditions.

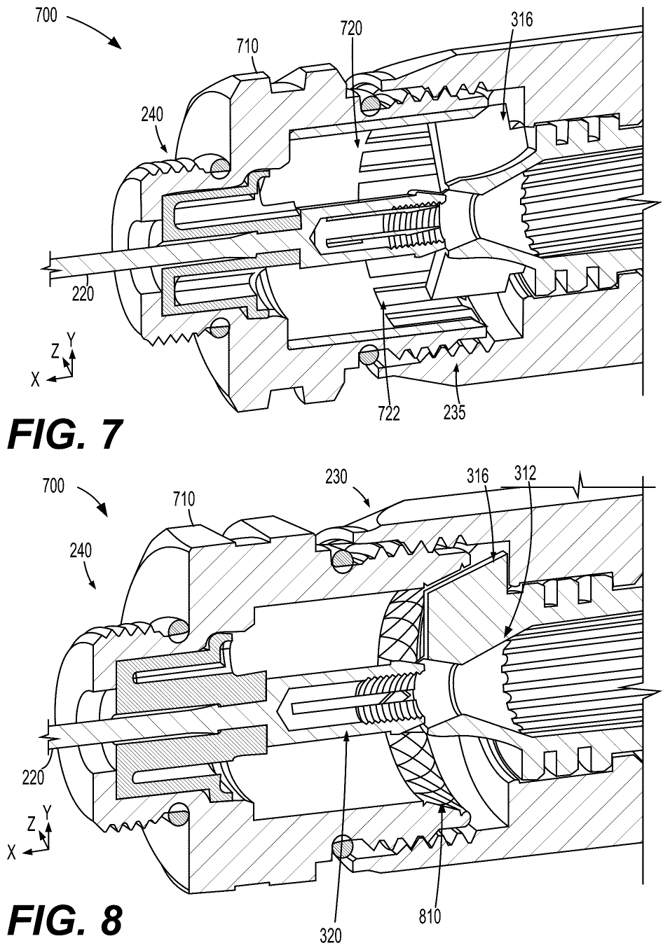

FIGS. 7 and 8 respectively illustrate cross-sectional views of portions of a hardline connector 700 arranged in accordance with various embodiments to provide a rotationally stable mandrel during installation of the first body portion 230 to the second body portion 240. In FIG. 7, a nut 710 of the second body portion 240 includes an insert portion 720 that has a number of radially separated slots 722 that can engage the cantilevered tabs 316 of the mandrel 310/510/610 to maintain position of the seizure portion 312/412 while the nut 710 is rotated to engage the threads 235 of the first body portion 230.

While the insert portion 720 can be installed into the nut 710 to mitigate, or prevent, rotation of the tabs 316 when the nut 710 is rotated relative to the first body structure 230, such configuration is not required. For instance, aspects of the nut 710 itself can be textured to provide reduced rotational friction with a mandrel tab 316 when the nut 710 is rotated to secure to the first body portion 230. As shown in the cross-sectional view of FIG. 8, a section 810 of the nut 710 is knurled with a number of grooves to retain the position of the mandrel 510/510/310 relative to the collet 320 once the nut 710 is fully engaged with the first body portion 230.

In accordance with various embodiments, the use of one or more tabs 316 continuously extending from the seizure portion 312 of a mandrel 310/510/610 provide at least two practical advantages over conventional hardline connector mandrels. First, the mandrel tab(s) 316 stabilize the position of the mandrel 310/510/610 during rotational installation of the nut 710 and second body portion 240. Second, the mandrel tab(s) 316 engage the nut 710 to prevent movement of the collet 320 or disruption of the connection between the collet 320 and seizure portion 312 over time. The ability to customize how the nut 710 is configured to physically engage the mandrel 310/510/610 allows for optimized functionality where the mandrel 310/510/610 is initially rotationally stable prior to engagement with the collet 320 and then, subsequently, locked with the nut 710 to prevent damage to the collet 320 or conductive pin 220 as the first body portion 230 mates with the second body portion 240.

Through the use of a hardline connector mandrel with integrated seizure, tube, and rotation arresting portions installation, cost, and operation of the connector can be improved. In other words, integration of a seizure bushing with a tube that forms the mandrel provides improved connector performance, decreased weight, and reduced cost compared to utilization of separate mandrel and seizure bushing components in a single connector or use of a mandrel with an exclusively metal construction. The interchangeability of mandrels in a hardline connector body further improves operational life and effectiveness as different mandrel designs and/or material constructions can be employed, at will, to customize the maintaining of a signal pathway through the connector.

Also, with respect to the various embodiments of the present disclosure, the components of the cable 110 can be constructed of various materials which have some degree of elasticity or flexibility. The elasticity enables the cable 110 to flex or bend in accordance with broadband communications standards, installation methods, or installation equipment. Also, the radial thicknesses of the cable 110, the signal pathway conductor 150, insulator 160, any shielding layers 170, and the outer jacket 180 can vary based upon parameters corresponding to broadband communication standards or installation equipment.

Additional embodiments include any one of the embodiments described above, where one or more of its components, functionalities or structures is interchanged with, replaced by or augmented by one or more of the components, functionalities or structures of a different embodiment described above. It should be understood that various changes and modifications to the embodiments described herein will be apparent to those skilled in the art. Such changes and modifications can be made without departing from the spirit and scope of the present disclosure and without diminishing its intended advantages. It is therefore intended that such changes and modifications be covered by the appended claims.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure, nor the claims which follow.

What is claimed is:

1. A hardline connector to interface between a cable and a terminal port, comprising a first body portion;
a second body portion structurally configured to be threadedly coupled with a first end of the first body portion;
a third body portion structurally configured to be threadedly coupled with a second end of the first body portion;
wherein the second body portion includes a conductive pin portion;
wherein the first body portion includes a mandrel portion comprising a seizure portion and a tubular portion;
wherein the third body portion is structurally configured to engage a clamping portion of the first body portion to secure the tubular portion in place within the first body portion;
wherein the seizure portion comprises a collar portion structurally configured to position a centering portion in contact with a collet portion of a pin conductor portion of the second body portion;
wherein the seizure portion is structurally configured to move axially relative to the collect portion to urge the collet portion radially inward so as to grip a center conductor portion of a hardline cable and permit electrical signals to be passed from the center conductor portion to the conductive pin portion;
wherein the seizure portion includes an engagement portion structurally configured to engage a retention portion of the first body portion;
wherein the engagement portion comprises a plurality of separated cantilevered tabs configured to engage the retention portion of the second body portion; and
wherein the conductive pin portion is structurally configured to engage a hardline port while the engagement portion and retention portion resist rotation of the mandrel portion and the center conductor portion relative to the second body portion during rotation of the second body portion relative to the first body portion to provide enhanced electrical and mechanical connections.

2. The hardline connector of claim 1, wherein the seizure portion and at least a portion of the tubular portion comprise a single monolithic structure.

3. The hardline connector of claim 2, wherein the monolithic structure is non-conductive.

4. The hardline connector of claim 2, wherein the monolithic structure results in improved connector performance, decreased weight, and reduced cost.

5. The hardline connector of claim 1, wherein at least a portion of the mandrel is configured to be positioned between an outer conductor of the cable and an insulator portion of the cable.

6. The hardline connector of claim 1, wherein the engagement portion extends from the mandrel portion to contact a retention sidewall of the first body portion.

7. The hardline connector of claim 6, wherein the retention sidewall is structurally configured to position the mandrel portion for physical engagement with the conductive pin portion in response to rotation of the second body portion relative to the first body portion.

8. The hardline connector of claim 1, wherein the second body portion comprises a centering member portion structurally configured to secure the pin conductor portion in place relative to the mandrel portion.

9. The hardline connector of claim 1, wherein the tubular portion has a plurality of longitudinal grooves positioned around a periphery of an internal cavity of the mandrel portion.

10. A cable connector comprising:
a first body portion;
a second body portion structurally configured to be threadedly coupled with the first body portion;
wherein the second body portion includes a conductive pin portion;
wherein the first body portion includes a mandrel portion comprising a seizure portion and a tubular portion;
wherein the seizure portion is structurally configured to move axially relative to a collect portion in the second body portion to urge the collet portion radially inward so as to grip a center conductor portion of a hardline cable and permit electrical signals to be passed from the center conductor portion to the conductive pin portion;
wherein the seizure portion includes an engagement portion structurally configured to engage a retention portion of the first body portion; and
wherein the conductive pin portion is structurally configured to engage a hardline port while the engagement portion and retention portion resist rotation of the mandrel portion and the center conductor portion relative to the second body portion during rotation of the second body portion relative to the first body portion to enhanced electrical and mechanical connections.

11. The cable connector of claim 10, wherein the engagement portion comprises a plurality of separated cantilevered tabs configured to engage the retention portion concurrently.

12. The cable connector of claim 11, wherein each tab of the plurality of cantilevered tabs is configured to engage a separate recess of the retention portion in the second body portion.

13. The cable connector of claim 12, wherein each recess of the retention portion comprises a rectangular notch orientated parallel to a longitudinal axis of the first body portion.

14. The cable connector of claim 11, wherein the plurality of separated cantilevered tabs is structurally configured to contact a retention surface of the first body portion to prevent movement of the mandrel portion along a longitudinal axis of the first body portion.

15. The cable connector of claim 11, wherein the seizure portion and at least a portion of the tubular portion comprise a single monolithic structure.

16. The cable connector of claim 15, wherein the plurality of grooves is structurally configured as a knurling that provides increased friction to the plurality of separated cantilevered tabs.

17. The cable connector of claim 15, wherein each tab of the plurality of separated cantilevered tabs concurrently physically contact separate grooves of the plurality of grooves to restrict rotation of the mandrel portion relative to the second body portion.

18. The cable connector of claim 10, wherein the tubular portion comprises a polymer section attached to a metal section via an attachment ring portion.

19. A connector comprising:
a first body portion;
a second body portion structurally configured to be threadedly coupled with the first body portion;
a mandrel portion comprising a seizure portion and a tubular portion;
wherein the seizure portion has a cantilevered engagement portion structurally configured to physically engage a retention portion of the second body portion;
wherein the tubular portion is structurally configured to position a center conductor portion of a cable in electrical contact with a conductive pin portion; and
wherein the conductive pin portion is structurally configured to engage a female port while the cantilevered engagement portion and retention portion collectively resist rotation of the mandrel portion and the center conductor portion relative to the second body portion to enhanced electrical and mechanical connections.

20. The connector of claim 19, wherein the seizure portion and at least a portion of the tubular portion comprise a single monolithic structure.
